(19) United States
(12) Patent Application Publication
(10) Pub. No.: US 2016/0109278 A1
(43) Pub. Date: Apr. 21, 2016

(54) Drum tank gauge device

(71) Applicant: Jeffrey Morris, Earlysville, VA (US)

(72) Inventor: Jeffrey Morris, Earlysville, VA (US)

(21) Appl. No.: 14/756,700

(22) Filed: Oct. 1, 2015

Related U.S. Application Data
(60) Provisional application No. 62/122,240, filed on Oct. 15, 2014.

(51) Int. Cl. G01F 23/26; G01F 23/292

(52) U.S. Cl. CPC G01F 23/263; G01F 23/292

(57) ABSTRACT

A drum tank gauge device is disclosed in which the device comprises a housing having a level indication display, an audible alarm, and a visual alarm, a level sensor shaft having a capacitance sensor positioned at an end which is inserted into a drum, and a threaded cap for securing the housing and the level sensor shaft in place.

### CROSS REFERENCE TO RELATED APPLICATION

This non-provisional patent application claims priority to the provisional patent application having Ser. No. 62/122,120, filed on Oct. 10, 2014.

### FIELD OF THE INVENTION

This disclosure generally relates to monitoring systems, and more particularly to a monitor for determining a level of a fluid, such as gasoline and oil, and other petroleum products, within a storage drum that provides visual fluid levels and audible and visual alarms.

### BACKGROUND OF THE INVENTION

A common device for storing and transporting liquid or granular material is a 55 gallon steel drum. The drum or container may contain material that may be either hazardous or non-hazardous. Generally, though, we are referring to gasoline and other petroleum products. The steel drum is typically provided with one or more threaded openings in the top of the container. One of the openings may be a 2 inch diameter bung hole opening that is used to fill or empty the container. Another one of the openings may be a ¾ inch diameter bung hole opening used for ventilation of the contents of the container. After filing the drum, these openings may be sealed by use of threaded caps to secure the contents within the drum. Once sealed, the drum is safe for transportation or storage. It is also known that the drum may include a corrosion resistant interior to protect against leakage for extended periods of storage or transportation.

Over time, the contents of the drum may be emptied, either fully or partially. In view of this, it is important to know the level of the contents within the drum. For example, if more than half of the contents of the drum are required, then it would be advantageous to know if the drum contains more than fifty percent of product. It would also be desirable to know when the drum is getting close to being depleted of its contents. In order to determine the level of the contents within the drum, various gauges have been used. For example, a float device may be inserted into the drum to determine the level of liquid contents. A stick gauge may also be inserted into the drum to determine the level of the contents within the drum. However, such gauges do not provide any warning or indication as to when the contents of the drum reaches a critical level.

The present disclosure is designed to obviate and overcome many of the disadvantages and shortcomings experienced with prior devices for determining a level of contents in a storage drum. Moreover, the present disclosure is related to a drum tank gauge device that can determine when the tank will be empty and to indicate that the tank is below a predetermined level.

### SUMMARY OF THE INVENTION

The present disclosure is a drum tank gauge device which comprises a housing having a level indication display, an audible alarm, and a visual alarm, a level sensor shaft having a capacitance sensor positioned at an end which is inserted into a drum, and a threaded cap for securing the housing and the level sensor shaft in place, for measuring the quantity of petroleum within a drum.

The present disclosure is also directed to a drum tank gauge device which comprises a housing having a level indication display, an audible alarm, and a visual alarm, a level sensor shaft having a capacitance sensor positioned at an end which is inserted into a drum, an integrated circuit connected to the level indication display, the audible alarm, the visual alarm, and the capacitance sensor, and a threaded cap for securing the housing and the level sensor shaft in place.

The present disclosure is a drum tank gauge device which comprises a housing having a level indication display, an audible alarm, a visual alarm, a first switch, and a second switch, a level sensor shaft having a capacitance sensor positioned at an end which is inserted into a drum, an integrated circuit connected to the level indication display, the audible alarm, the visual alarm, the first switch, the second switch, and the capacitance sensor, and a threaded cap for securing the housing and the level sensor shaft in place.

In light of the foregoing comments, it will be recognized that the present disclosure provides a drum tank gauge device that can monitor both an empty condition and a full condition in a storage drum.

The present disclosure provides a drum tank gauge device that can be easily employed with highly reliable results to prevent not knowing when a drum tank is about to be emptied.

The present disclosure also provides a drum tank gauge device that may be easily used with existing 55 gallon steel storage drums.

The present disclosure further provides a drum tank gauge device that provides both an audible alarm and a visual alarm when an empty condition is occurring.

The present disclosure provides a drum tank gauge device that requires only a few tools for installation in a drum or removal from a drum.

The present disclosure provides a drum tank gauge device that is easy to program various operating conditions.

The present disclosure is further directed to a drum tank gauge device that can replace existing gauges and does not require a storage drum to be retrofitted for use of the drum tank gauge device of the present disclosure.

The present disclosure also provides a drum tank gauge device that can be constructed of readily available components into a unitary construction for easy installation into a storage drum.

These and other advantages of the present disclosure will become apparent to those skilled in the art after considering the following detailed specification in conjunction with the accompanying drawings.

### BRIEF DESCRIPTION OF THE DRAWINGS

In referring to the drawings:

FIG. 1 is a partial perspective view of a drum tank gauge device constructed according to the present disclosure;

FIG. 2 is a partial right side perspective view of the drum tank gauge device constructed according to the present disclosure;

FIG. 3 is a partial left side perspective view of the drum tank gauge device constructed according to the present disclosure; and

FIG. 4 is a schematic block diagram of the drum tank gauge device constructed according to the present disclosure.

### DESCRIPTION OF THE PREFERRED EMBODIMENT

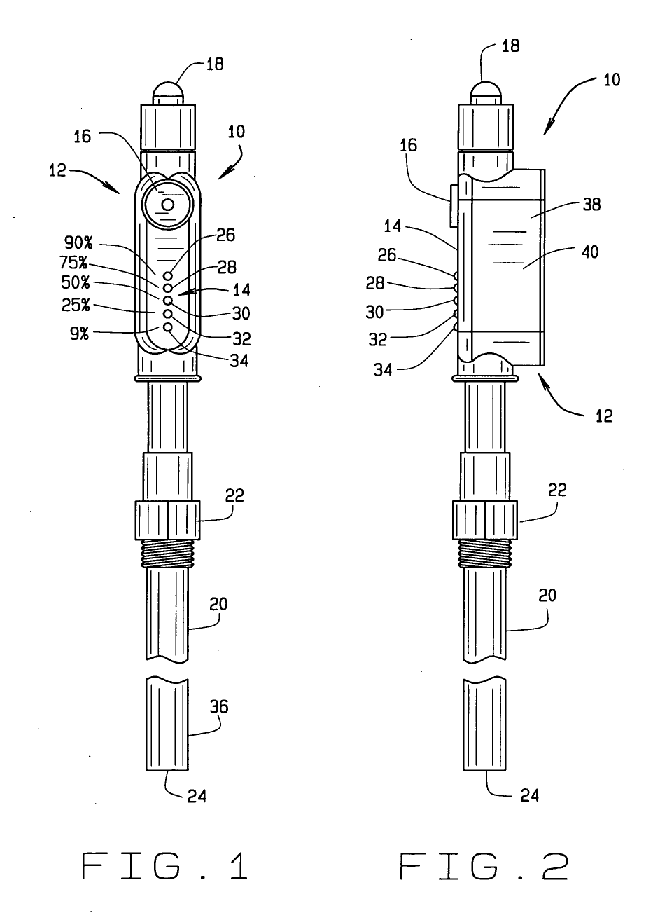

Referring now to the drawings, wherein like numbers refer to like items, number 10 identifies a preferred embodiment of a drum tank gauge device constructed according to the present disclosure. Such a drum tank will hold petroleum products. With reference now to FIG. 1, the drum tank gauge device 10 is shown comprising a housing or body 12 having a level indication display 14, a speaker or buzzer 16, a visual alarm 18, a level sensor shaft or stick 20, a threaded cap 22, and a capacitance sensor 24. The level indication display 14 has a first LED (light emitting diode) 26 to indicate that the drum is 90% full, a second LED 28 to indicate that the drum is 75% full, a third LED 30 to indicate that the drum is 50% full, a fourth LED 32 to indicate that the drum is 25% full, and a fifth LED 34 to indicate that the drum is 5% full. The LEDs 26, 28, 30, 32, and 34 can be used to indicate other conditions of the device 10, as will be explained more fully herein. The speaker 16 is used to provide an audible alarm as to the level of the contents within a drum (not shown). The level sensor stick 20 is placed in the drum through one of the openings, such as a ¾ inch bung hole or a 2 inch bung hole provided in a top of the drum. The level sensor stick 20 has the threaded cap 22 positioned thereon. The threaded cap 22 is used to thread the device 10 onto one of the threaded openings in the top of the drum. In this manner, the device 10 will be secured in place to the drum. The level sensor stick 20 has an end 36 that houses the capacitance sensor 24. The capacitance sensor 24 may be in contact with the contents of the drum and senses various levels of the contents within the drum. The visual alarm 18 may be an LED that is illuminated to indicate an alarm condition. The body 12 also houses various components, as will be described in detail further herein.

FIG. 2 illustrates a right side perspective view of the drum tank gauge device 10. The device 10 has a side 38 having a touch sensitive surface or switch 40 for actuating various functions of the device 10. The device 10 is further shown having the body 12, the level indication display 14, the speaker 16, the visual alarm 18, the level sensor shaft or stick 20, the threaded cap 22, and the capacitance sensor 24. The LEDs 26, 28, 30, 32, and 34 are also shown extending out from the level indication display 14.

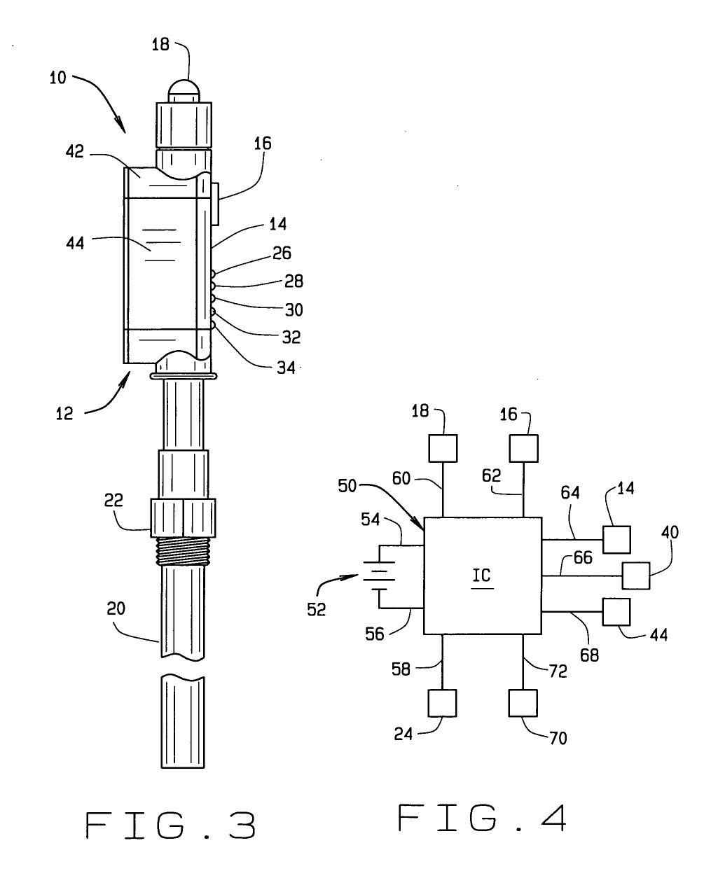

With reference now to FIG. 3, a left side perspective view of the drum tank gauge device 10 is depicted. The device 10 has a side 42 that incorporates a touch sensitive surface or switch 44 that is used to control various functions of the device 10. The device 10 has the body 12, the level indication display 14, the speaker 16, the visual alarm 18, the level sensor shaft or stick 20, the threaded cap 22, and the capacitance sensor 24. The LEDs 26, 28, 30, 32, and 34 are also shown extending out from the level indication display 14.

FIG. 4 illustrates a schematic block diagram of the drum tank gauge device 10 constructed according to the present disclosure. The device 10 has an integrated circuit (IC) device 50 that is powered by a battery 52 connected to the IC 50 via leads 54 and 56. The IC device may be by way of example a microprocessor, a microcontroller, an ASIC (application specific integrated circuit) chip, an ASSC (application specific standards product) chip. The battery 52 may be a single battery or two or more batteries. For example, the battery 52 may be a pair of AA batteries that may be inserted into the body 12. As can be appreciated, the battery 52 may be replaced when there is an indication that the battery 52 is low, as will be explained. The capacitance sensor 24 is connected to the IC 50 by a wire 58. A lead 60 connects the visual alarm 18 to the IC 50. The speaker 16 is connected to the IC 50 via a wire 62. The visual display 14, which include the LEDs 26, 28, 30, 32, and 34, which are not shown in this particular drawing, is connected to the IC 50 by a lead 64. The switch 40 is connected to the IC 50 by a wire 66. A lead 68 is used to connect the switch 44 to the IC 50. A switch 70 is also connected to the IC 50 by use of a wire 72. The purpose for the switch 70 will be explained. The IC 50 and the various components 14, 16, 18, 40, 44 and 70 may be housed within the body 12. Further, the capacitance sensor 24 may be positioned within the shaft 20 with the wire 58 running through the shaft 20. Although several of the wires, such as the wires 58, 60, 62, 64, 66, 68, and 72 have been depicted as being a single wire, it is possible that there may be more than one wire. A single wire has been shown for purposes of clarity.

The device 10 may be operated in the following manner. The shaft 20 of the device 10 is inserted into a bung opening provided in a top of a drum. The threaded cap 22 is threaded into place in a threaded portion associated with the bung opening. The device 10 should be installed completely vertical within the drum. Also, the drum should be placed on a flat, level surface. Once it is determined that the device 10 is fully inserted into the drum and vertical, the device 10 will automatically turn on and the capacitance sensor 24 will provide a signal over the wire 58 to the IC 50. The IC 50 will then determine the level of the contents of the drum based on the signal received from the sensor 24. The IC 50 may be controlled by a program that is stored in memory or in a program storage area. Further, the IC 50 may include various other components, which are not shown, but which are well known. A signal will then be sent out over wire 62 to actuate the speaker 16 to produce a beeping sound and if the drum is filled to at least 5% capacity then a signal will be sent out on the wire 64 to the level indication display 14 and one of the LEDs 26, 28, 30, 32, or 34 will be illuminated for a set period of time. After the initial indication of the level in the drum is displayed, the current level of fluid in the drum may be initiated by pressing one or both of the switches 40 and 44. This will activate the capacitance sensor 24, which will send a signal to the IC 50. The IC 50 will interpret this signal to determine the level of fluid in the drum. Once this determination has been completed, the IC 50 will send a signal to the level indication display 14 to illuminated one of the LEDs 26, 28, 30, 32, or 34. The level indication display 14 will be illuminated for a preset period of time, such as twenty seconds.

When the fluid level is below approximately 5% capacity, the device 10 will automatically flash both the visual alarm 18 and the LED 34. If the switch 70 is operated or in a closed position then the speaker or buzzer 16 will be operated. If the switch 70 is in an opened position then the speaker 16 will not be operated and only the visual alarm 18 and the LED 34 will be operated to indicate a low fluid condition within the drum. Optionally, if the switch 70 is closed and the speaker 16 is buzzing, then the speaker 16 can be temporarily silenced or muted by pressing both of the switches 40 and 44. The speaker 16 will not operate again in this condition until the fluid level in the drum falls below 5% capacity again, after filing the drum, or the device 10 is removed and then reinstalled into a drum. The switch 70 may be enclosed in the housing 12 where the battery 52 is located.

The device 10 can indicate that the battery 52 is low by a periodic chirping signal through the speaker 16, blinking the LEDs 26, 30, and 34, and illuminating the visual alarm 18. Once a low battery 52 condition is indicated, the battery 52 should be replaced immediately because the device 10 will not be able to display an accurate reading of the level of the drum.

As can be appreciated, the drum tank gauge device 10 may be used with existing or new drums having a bung opening in the top of the drum. The device 10 may also use an adapter to align the device 10 within the drum in a vertical orientation within the drum. Due to the capacitance sensor 24, the device 10 needs to be used in conjunction with a steel drum. The sensor 24 will not function properly in a plastic drum. Further, when the device 10 is removed from the drum, the device 10 will automatically turn off which will save the battery 52 installed in the device 10. Also, if the device 10 will not be used for an extended period of time, then the battery 52 should be removed from within the housing 12.

From all that has been said, it will be clear that there has thus been shown and described herein a drum tank gauge device. It will become apparent to those skilled in the art, however, that many changes, modifications, variations, and other uses and applications of the subject drum tank gauge device are possible and contemplated. All changes, modifications, variations, and other uses and applications which do not depart from the spirit and scope of the disclosure are deemed to be covered by the disclosure, which is limited only by the claims which follow.

I claim:

1. A drum tank gauge device for use in measuring the quantity of petroleum products in a drum tank, comprising:
a housing having a level indication display, an audible alarm, and a visual alarm;
a level sensor shaft having a capacitance sensor positioned at an end which is inserted into a drum; and
a threaded cap for securing the housing and the level sensor shaft in place.

2. The drum tank gauge device of claim 1 wherein the level indication display comprises a first LED for indicating 90% capacity, a second LED for indicating 75% capacity, a third LED for indicating 50% capacity, a fourth LED for indicating 25% capacity, and a fifth LED for indicating 5% capacity.

3. The drum tank gauge device of claim 1 wherein the visual alarm is an LED.

4. The drum tank gauge device of claim 1 wherein the audible alarm is a speaker.

5. The drum tank gauge device of claim 1 wherein the housing further comprises a side having a touch sensitive switch for operating the drum tank gauge device.

6. The drum tank gauge device of claim 1 wherein the housing further comprises a switch for muting the operation of the audible alarm.

7. The drum tank gauge device of claim 1 further comprising a battery positioned within the housing for powering the drum tank gauge device.

8. A drum tank gauge device for use in measuring the quantity of petroleum products in a drum tank, comprising:
a housing having a level indication display, an audible alarm, and a visual alarm;
a level sensor shaft having a capacitance sensor positioned at an end which is inserted into a drum;
an integrated circuit connected to the level indication display, the audible alarm, the visual alarm, and the capacitance sensor; and
a threaded cap for securing the housing and the level sensor shaft in place.

9. The drum tank gauge device of claim 8 wherein the level indication display comprises a first LED for indicating 90% capacity, a second LED for indicating 75% capacity, a third LED for indicating 50% capacity, a fourth LED for indicating 25% capacity, and a fifth LED for indicating 5% capacity.

10. The drum tank gauge device of claim 8 wherein the housing further comprises a side having a switch connected to the integrated circuit, operation of the switch for actuating the capacitance sensor for providing a signal to the integrated circuit for the integrated circuit to determine a level of contents within a drum.

11. The drum tank gauge device of claim 10 wherein the switch is a touch sensitive switch.

12. The drum tank gauge device of claim 8 wherein the visual alarm is an LED.

13. The drum tank gauge device of claim 8 wherein the audible alarm is a buzzer.

14. The drum tank gauge device of claim 8 wherein the housing further comprises a switch for muting the operation of the audible alarm.

15. The drum tank gauge device of claim 8 further comprising a battery positioned within the housing for providing power to the integrated circuit.

16. A drum tank gauge device for use in measuring the quantity of petroleum products in a drum tank, comprising:
a housing having a level indication display, an audible alarm, a visual alarm, a first switch, and a second switch;
a level sensor shaft having a capacitance sensor positioned at an end which is inserted into a drum;
an integrated circuit connected to the level indication display, the audible alarm, the visual alarm, the first switch, the second switch, and the capacitance sensor; and
a threaded cap for securing the housing and the level sensor shaft in place.

17. The drum tank gauge device of claim 16 wherein the level indication display comprises a first LED for indicating 90% capacity, a second LED for indicating 75% capacity, a third LED for indicating 50% capacity, a fourth LED for indicating 25% capacity, and a fifth LED for indicating 5% capacity.

18. The drum tank gauge device of claim 16 wherein operation of the first switch actuates the capacitance sensor for providing a signal to the integrated circuit for the integrated circuit to determine a level of contents within the drum.

19. The drum tank gauge device of claim 16 wherein operation of the second switch actuates the capacitance sensor for providing a signal to the integrated circuit for the integrated circuit to determine a level of contents within the drum.

20. The drum tank gauge device of claim 16 wherein the housing further comprises a switch for muting the operation of the audible alarm.
